(19) United States
(12) Patent Application Publication
(10) Pub. No.: US 2024/0305545 A1
(43) Pub. Date: Sep. 12, 2024

(54) THROTTLING IN A MULTITENANT ENVIRONMENT

(71) Applicant: International Business Machines Corporation, Armonk, NY (US)

(72) Inventors: Bharti Soni, Pune (IN); Subhojit Roy, Pune (IN); Komal Shailendra Shah, Pune (IN); Tej Parkash, Pune (IN)

(21) Appl. No.: 18/178,700

(22) Filed: Mar. 6, 2023

(51) Int. Cl. H04L 41/5019

(52) U.S. Cl. CPC H04L 41/5019

(57) ABSTRACT

Computer-implemented methods for throttling in a multitenant environment are provided. Aspects include assigning, by a system administrator of the multitenant environment, a service level for each tenant of a plurality of tenants of the multitenant environment and obtaining a throttling value for each of a plurality of hosts associated with each of the plurality of tenants in the multitenant environment. Aspects also include monitoring, by a controller of the multitenant environment, an activity level for each of the plurality of tenants of the multitenant environment. Based on a determination that the activity level for one of the plurality of tenants has reached a maximum value specified by the service level, aspects include throttling one or more of the plurality of hosts associated with the one of the plurality of tenants based on the throttling value for the one or more of the plurality of hosts.

### BACKGROUND

The present disclosure generally relates to multitenant computing environments, and more specifically, to throttling in a multitenant environment.

In a multitenant environment storage application allows the creation of a large number of disks that cater to input/output (I/O) requests from multiple tenants. Since each tenant can have several hosts or host groups with varied performance requirements, it is possible that a small number of hosts within a single tenant can consume a large amount of controller resources and adversely impact another set of hosts belonging to the same or different tenant. Hence, I/O throttling in a multitenant environment became a common feature to control the allocation of resources. In general, throttling is a mechanism to control number of resources consumed in serving I/Os to a specific disk or through a specific host. Throttling can be implemented based on input/output operations per second (IOPS), bandwidth, a combination of the two or any other resources.

### SUMMARY

Embodiments of the present disclosure are directed to computer-implemented methods for throttling in a multitenant environment. According to an aspect, a computer-implemented method includes assigning, by a system administrator of the multitenant environment, a service level for each tenant of a plurality of tenants of the multitenant environment and obtaining a throttling value for each of a plurality of hosts associated with each of the plurality of tenants in the multitenant environment. The method also includes monitoring, by a controller of the multitenant environment, an activity level for each of the plurality of tenants of the multitenant environment. Based on a determination that the activity level for one of the plurality of tenants has reached a maximum value specified by the service level, the method also includes throttling one or more of the plurality of hosts associated with the one of the plurality of tenants based on the throttling value for the one or more of the plurality of hosts.

According to another non-limiting embodiment of the disclosure, a system having a memory having computer readable instructions and one or more processors for executing the computer readable instructions, the computer readable instructions controlling the one or more processors to perform operations. The operations include assigning, by a system administrator of the multitenant environment, a service level for each tenant of a plurality of tenants of the multitenant environment and obtaining a throttling value for each of a plurality of hosts associated with each of the plurality of tenants in the multitenant environment. The operations also include monitoring, by a controller of the multitenant environment, an activity level for each of the plurality of tenants of the multitenant environment. Based on a determination that the activity level for one of the plurality of tenants has reached a maximum value specified by the service level, the operations also include throttling one or more of the plurality of hosts associated with the one of the plurality of tenants based on the throttling value for the one or more of the plurality of hosts.

According to another non-limiting embodiment of the disclosure, a computer program product for throttling in a multitenant environment is provided. The computer program product includes a computer-readable storage medium having program instructions embodied therewith, the program instructions executable by a processor to cause the processor to perform operations. The operations include assigning, by a system administrator of the multitenant environment, a service level for each tenant of a plurality of tenants of the multitenant environment and obtaining a throttling value for each of a plurality of hosts associated with each of the plurality of tenants in the multitenant environment. The operations also include monitoring, by a controller of the multitenant environment, an activity level for each of the plurality of tenants of the multitenant environment. Based on a determination that the activity level for one of the plurality of tenants has reached a maximum value specified by the service level, the operations also include throttling one or more of the plurality of hosts associated with the one of the plurality of tenants based on the throttling value for the one or more of the plurality of hosts.

Additional technical features and benefits are realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the present disclosure are apparent from the following detailed description taken in conjunction with the accompanying drawings in which:

FIG. 1 depicts a block diagram of an example computer system for use in conjunction with one or more embodiments of the present disclosure;

FIG. 2 depicts a block diagram of components of a machine learning training and inference system in accordance with one or more embodiments of the present disclosure;

FIG. 3 depicts a block diagram of a multitenant environment in accordance with one or more embodiments of the present disclosure;

FIGS. 4A and 4B depict block diagrams of the allocation of resources for configuring throttling in a multitenant environment in accordance with one or more embodiments of the present disclosure;

FIG. 5 is a flowchart of a method for throttling in a multitenant environment in accordance with one or more embodiments of the present disclosure; and

FIG. 6 is a flowchart of a method for throttling in a multitenant environment in accordance with one or more embodiments of the present disclosure.

### DETAILED DESCRIPTION

In a multitenant environment, one tenant can set throttle values for their own hosts or volumes, but that tenant may not be aware of other tenants in the multitenant environment, how many tenants are sharing hosts in the multitenant environment, and/or what kind of applications other tenants are running. Tenants do not have enough knowledge of the multitenant environments to be able to fairly set throttle values. Hence in a multitenant environment, a per tenant throttle value is configured to ensure each tenant has adequate resources.

In exemplary embodiments, throttling in a multitenant environment is based on a two-level throttling system that includes a per tenant throttling value and per resource (i.e., per host) throttling values. In exemplary embodiments, the per tenant throttle value generated (or set by the system administrator) and control the total resources (IOPS, bandwidth, etc.) committed to each tenant and the tenants do not have the ability to change these throttle values. In exemplary embodiments, these throttle values will be based on a service level associated with each tenant. For example, gold level tenants could be assigned 10000 IOPs and 20 Gbps of bandwidth while silver level tenants could be assigned 5000 IOPs and 10 Gbps of bandwidth. In exemplary embodiments, each tenant is able to set throttle values for each of its own hosts, storage resources or host groups. In some embodiments, the sum of all the per resource throttle values is more than the total throttle value assigned to the tenant.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as throttling in a multitenant environment 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

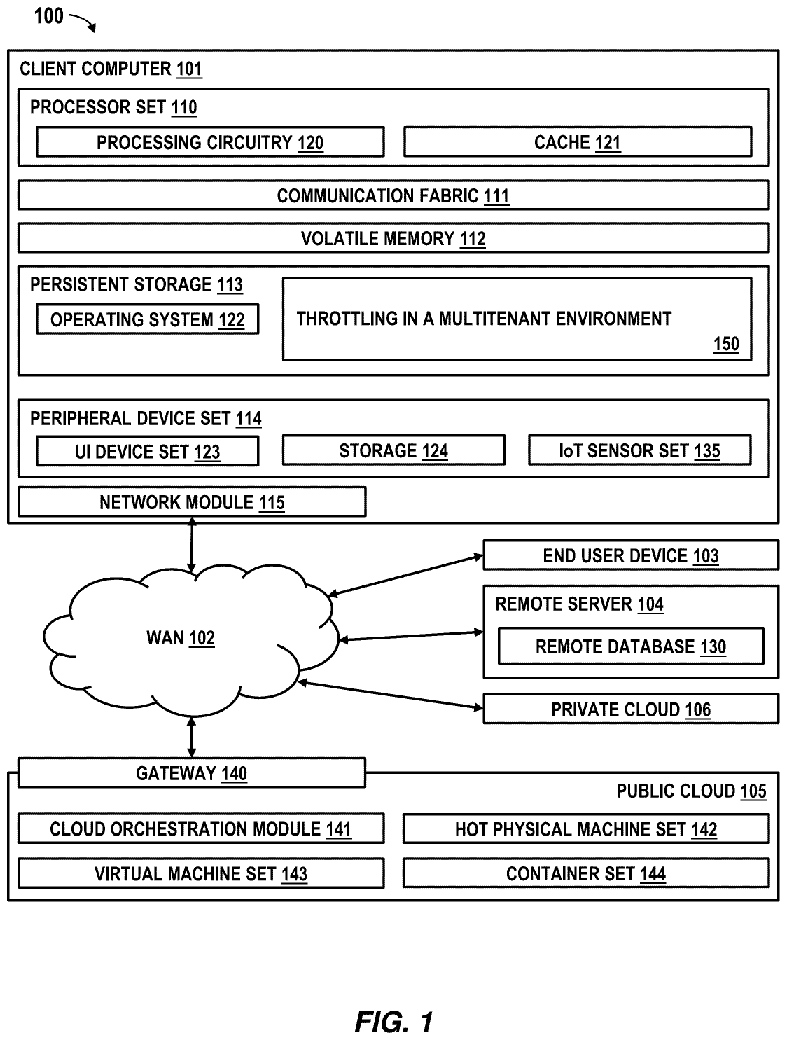

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

One or more embodiments described herein can utilize machine learning techniques to perform prediction and or classification tasks, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input. It should be appreciated that these same techniques can be applied in the case of containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

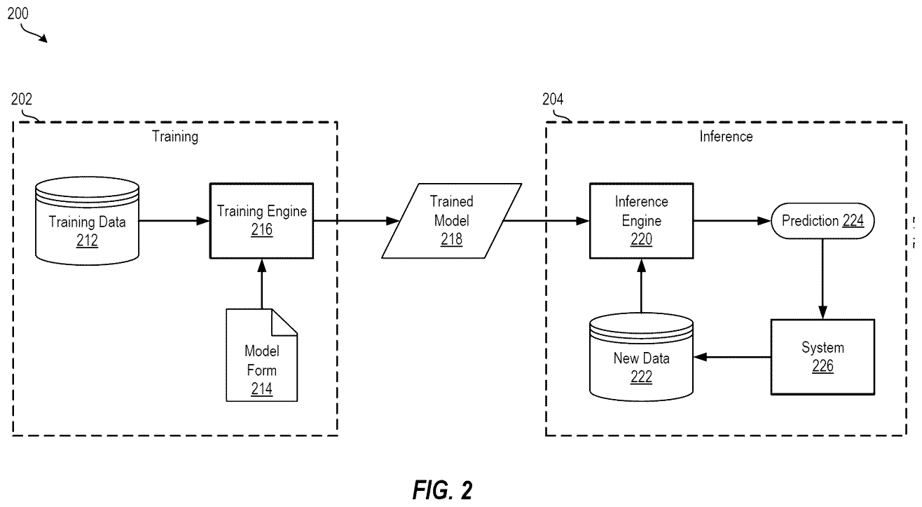

Systems for training and using a machine learning model are now described in more detail with reference to FIG. 2. Particularly, FIG. 2 depicts a block diagram of components of a machine learning training and inference system 200 according to one or more embodiments described herein. The system 200 performs training 202 and inference 204. During training 202, a training engine 216 trains a model (e.g., the trained model 218) to perform a task, such as setting throttling values for hosts in a multitenant environment. Inference 204 is the process of implementing the trained model 218 to perform the task, such as setting throttling values for hosts in a multitenant environment, in the context of a larger system (e.g., a system 226). All or a portion of the system 200 shown in FIG. 2 can be implemented, for example by all or a subset of the computing environment 100 of FIG. 1.

The training 202 begins with training data 212, which may be structured or unstructured data. According to one or more embodiments described herein, the training data 212 includes utilization data for each node of a tenant in the multitenant environment. The training engine 216 receives the training data 212 and a model form 214. The model form 214 represents a base model that is untrained. The model form 214 can have preset weights and biases, which can be adjusted during training. It should be appreciated that the model form 214 can be selected from many different model forms depending on the task to be performed. For example, where the training 202 is to train a model to perform image classification, the model form 214 may be a model form of a CNN. The training 202 can be supervised learning, semi-supervised learning, unsupervised learning, reinforcement learning, and/or the like, including combinations and/or multiples thereof. For example, supervised learning can be used to train a machine learning model to classify an object of interest in an image. To do this, the training data 212 includes labeled images, including images of the object of interest with associated labels (ground truth) and other images that do not include the object of interest with associated labels. In this example, the training engine 216 takes as input a training image from the training data 212, makes a prediction for classifying the image, and compares the prediction to the known label. The training engine 216 then adjusts weights and/or biases of the model based on results of the comparison, such as by using backpropagation. The training 202 may be performed multiple times (referred to as “epochs”) until a suitable model is trained (e.g., the trained model 218).

Once trained, the trained model 218 can be used to perform inference 204 to perform a task, such as setting throttling values for hosts in a multitenant environment. The inference engine 220 applies the trained model 218 to new data 222 (e.g., real-world, non-training data). For example, if the trained model 218 is trained to classify images of a particular object, such as a chair, the new data 222 can be an image of a chair that was not part of the training data 212. In this way, the new data 222 represents data to which the model 218 has not been exposed. The inference engine 220 makes a prediction 224 (e.g., a classification of an object in an image of the new data 222) and passes the prediction 224 to the system 226. The system 226 can, based on the prediction 224, taken an action, perform an operation, perform an analysis, and/or the like, including combinations and/or multiples thereof. In some embodiments, the system 226 can add to and/or modify the new data 222 based on the prediction 224.

In accordance with one or more embodiments, the predictions 224 generated by the inference engine 220 are periodically monitored and verified to ensure that the inference engine 220 is operating as expected. Based on the verification, additional training 202 may occur using the trained model 218 as the starting point. The additional training 202 may include all or a subset of the original training data 212 and/or new training data 212. In accordance with one or more embodiments, the training 202 includes updating the trained model 218 to account for changes in expected input data.

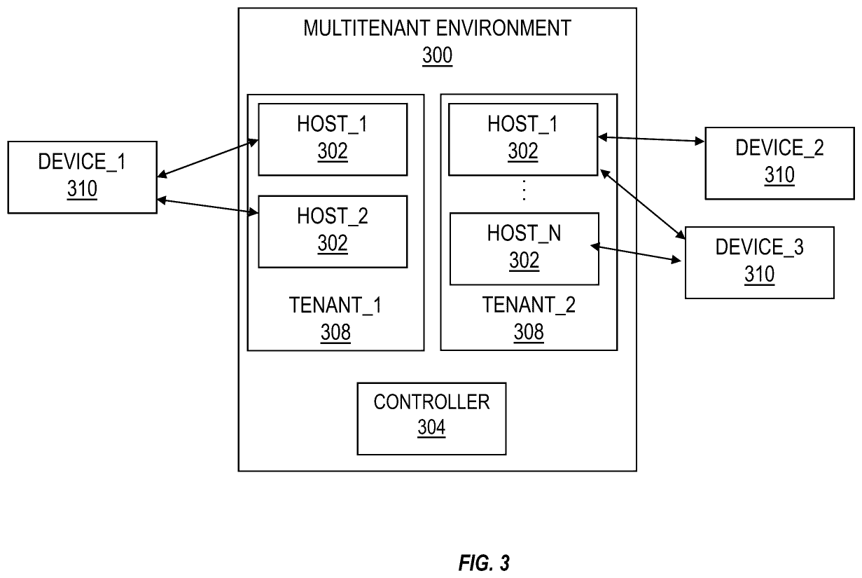

Referring now to FIG. 3, a block diagram of a multitenant environment 300 in accordance with one or more embodiments of the present disclosure. The multitenant environment 300 includes a plurality of hosts 302 that are utilized by one of the tenants 308 of the multitenant environment 300. In exemplary embodiments, one or more of the hosts 302 are dedicated to a single tenant 308. In exemplary embodiments, devices 310 are configured to access the hosts 302 of the multitenant environment 300. Each device 310 is associated with a tenant 308 of the multitenant environment 300. The multitenant environment 300 also includes a controller 304 that is configured to monitor access of the hosts 302 for each tenant 308 and to perform throttling actions based on a determination that an activity level of hosts 302 associated with a tenant 308 exceeds a service level of the tenant.

In exemplary embodiments, the multitenant environment 300 may be embodied in a computing environment 100, such as the one shown in FIG. 1. In one embodiment, each host 302 is a data storage device. In one embodiment, the service level associated with each tenant is assigned by a system administrator of the multitenant environment 300 based on the subscription or service level of the tenant. The service level includes one or more of a maximum bandwidth that each tenant can utilize and a maximum IOPS for the tenant.

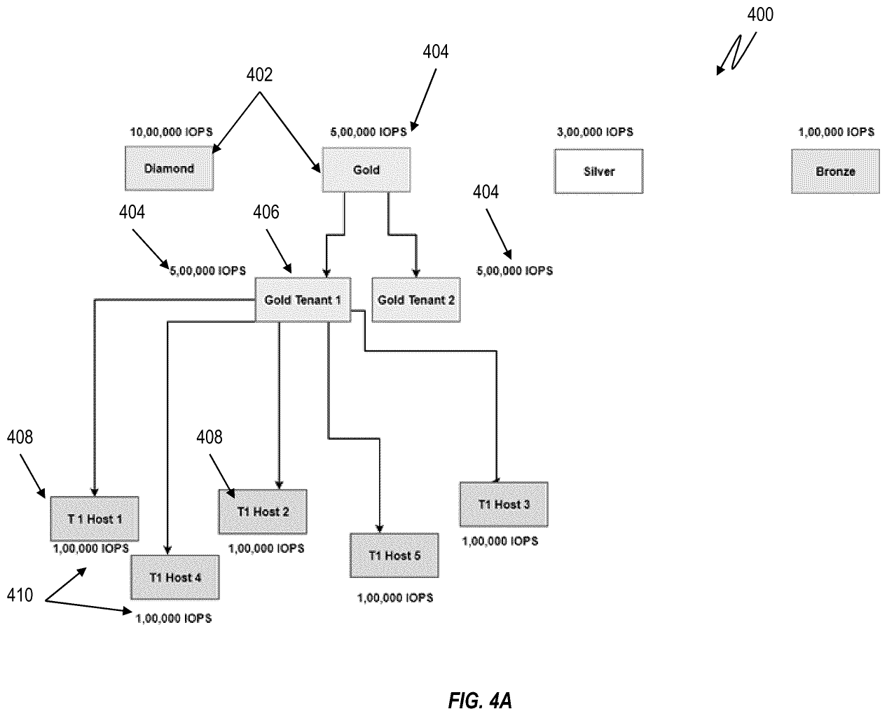

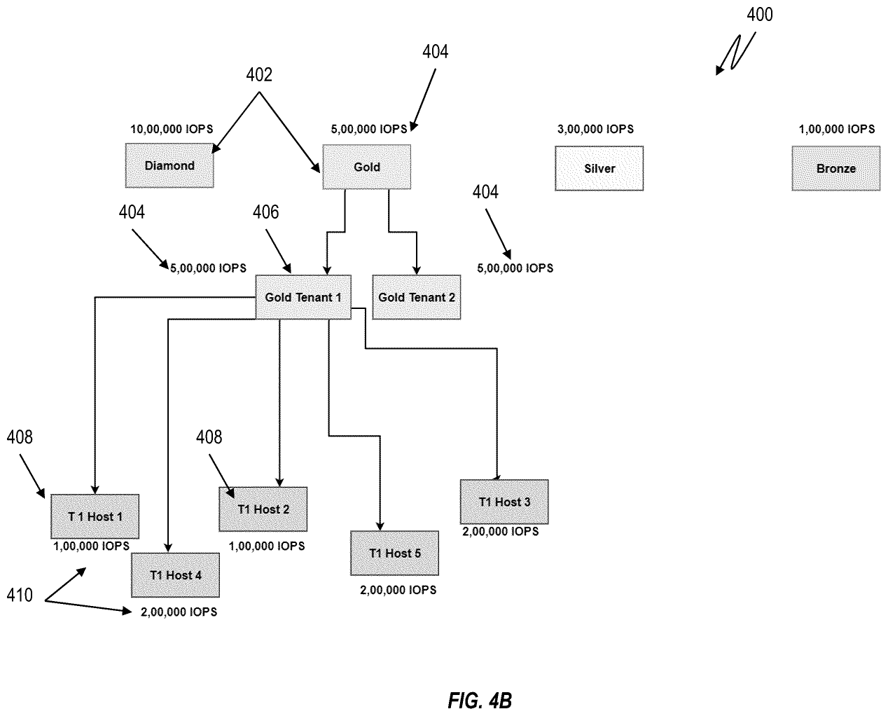

Referring now to FIGS. 4A and 4B, block diagrams of the allocation of resources for configuring throttling in a multitenant environment in accordance with an embodiment of the present disclosure are shown. As illustrated, the multitenant environment includes multiple service levels 402, such as diamond, gold, silver, and bronze, and each service level includes a maximum value 404. In one embodiment, the maximum value 404 is specified in terms of IOPS (as shown) and in other embodiments, the maximum value 404 is specified in terms of bandwidth. In exemplary embodiments, the multitenant environment includes a plurality of tenants 406 that are each associated with a service level 402.

In exemplary embodiments, each of the tenants 406 is associated with one or more hosts 408 and the maximum value 404 is the total amount of resources that each tenant 406 can use across all of its hosts 408. In exemplary embodiments, each of the hosts 408 of a tenant 406 is assigned a host maximum value 410, which is the maximum number of resources that each host 408 of a tenant 406 can consume. In one embodiment, tenant 406 assigns the host maximum value 410 to each host 408. In one embodiment, as shown in FIG. 4A, the host maximum values 410 assigned to each host 408 adds up to the maximum value 404 for the host. In this embodiment, each host 408 of the tenant 406 is throttled by a throttling value, which is equal to the host maximum value 410, when a usage of the host 408 reaches the host maximum value 410.

In another embodiment, as shown in FIG. 4B, the host maximum value 410 assigned to each host 408 adds up to a number larger than the maximum value 404 for the host. In this embodiment, one or more hosts 408 of the tenant 406 are throttled when a usage of the host 408 reaches the host maximum value 410. Based on a determination that the combined usage of the hosts 408 of a tenant 406 reach the maximum value 404, the usage of the hosts 408 are throttled based on their relative host maximum value 410. In one embodiment, a throttling value a first host 408 of a tenant 406 is calculated by dividing a host maximum value 410 assigned to the first host 408 by the sum of the host maximum values 410 for the tenant 406 and multiplying the quotient by the maximum value 404. For example, the throttling value of Host 1 is calculated to be 625,000 IOPs which is equal to (1,000,000/8,000,000)*5,000,000) and the throttling value of Host 2 is calculated to be 1,250,000 IOPs which is equal to (2,000,000/8,000,000) *5,000,000).

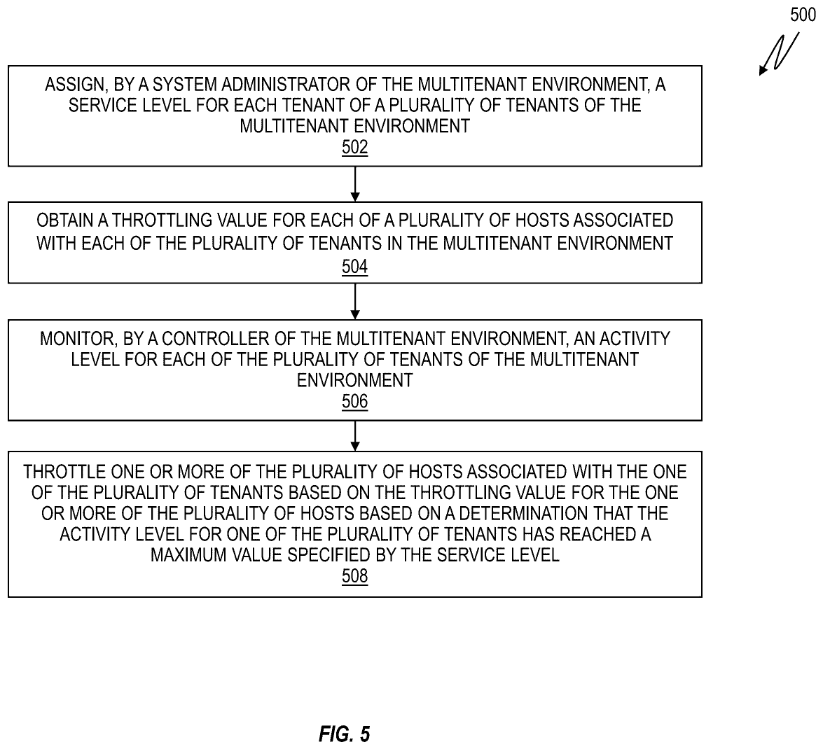

Referring now to FIG. 5, a flowchart of a method 500 for throttling in a multitenant environment in accordance with one or more embodiments of the present disclosure is shown. As shown at block 502, the method 500 includes assigning, by a system administrator of the multitenant environment, a service level for each tenant of a plurality of tenants of the multitenant environment. In exemplary embodiments, the service level is selected from a set of service levels offered by the multitenant environment and each service level includes a maximum value that corresponds to the maximum amount of computing resources of the multitenant environment that the tenant can use.

Next, as shown at block 504, the method 500 includes obtaining a throttling value for each of a plurality of hosts associated with each of the plurality of tenants in the multitenant environment. In one embodiment, the throttling value for each of a plurality of hosts associated with a tenant of the plurality of tenants is received from the tenant. In another embodiment, the throttling value for each of a plurality of hosts is initially set to a default value and the throttling value is automatically updated during the operation of the multitenant environment based on a machine learning algorithm. The default value may be determined based on one or more factors including the number of hosts of the tenant, the number of active connections from a host of the tenant, the total number of active connections from all hosts of the tenant, a type of applications that the host is running, or the like. In exemplary embodiments, the machine learning algorithm monitors the usage of each of the hosts and adjusts the throttling value for each of a plurality of hosts to maximize the utilization of the service level of the tenant. In some embodiments, the machine learning algorithm may also take into account an importance ranking, that is provided by the tenant, for each of the hosts.

Next, as shown at block 504, the method 500 includes monitoring, by a controller of the multitenant environment, an activity level for each of the plurality of tenants of the multitenant environment. In exemplary embodiments, the activity level of a tenant is calculated as the sum of the activity levels of each of the hosts associated with the tenant. The method 500 also includes throttling one or more of the plurality of hosts associated with the one of the plurality of tenants based on the throttling value for the one or more of the plurality of hosts based on a determination that the activity level for one of the plurality of tenants has reached a maximum value specified by the service level. In one embodiment, the maximum value specified by the service level is the maximum number of input/output operations per second (IOPS) permitted by the tenant. In another embodiment, the maximum value specified by the service level is the maximum bandwidth permitted to be used by the tenant.

In one embodiment, a sum of the throttling values for the plurality of hosts associated with a tenant is equal to the maximum value specified by the service level. In another embodiment, the sum of the throttling values for the plurality of hosts associated with a tenant is greater than the maximum value specified by the service level. In this embodiment, the throttling value of the first host of the plurality of hosts is calculated by dividing a host throttling value for the first host by the sum of the throttling values for the plurality of hosts and multiplying a quotient by the maximum value specified by the service level.

In exemplary embodiments, the method 500 may also include notifying a tenant of a throttling even based on the throttling of a host associated with the tenant. In some embodiments, the notification includes an indication of the current service level of the tenant, a cost of the current service level, a higher service level, and a cost difference between the cost of the current service level and the cost of the higher service. The notification may also include a link for a user to click on to upgrade to the higher service level. In other embodiments, the notification may include an option to borrow additional resources from another tenant and the associated cost of borrowing these resources. In some embodiments, based on a determination that a tenant regularly exceeds its capacity and borrows resources from other tenants, the notification can include a summary of the borrowing costs that the tenant has paid and a comparison of the cost to upgrade to a service level that includes sufficient resources for the tenants needs. In exemplary embodiments, a tenant can borrow resources from other tenant of same service level or a different service level.

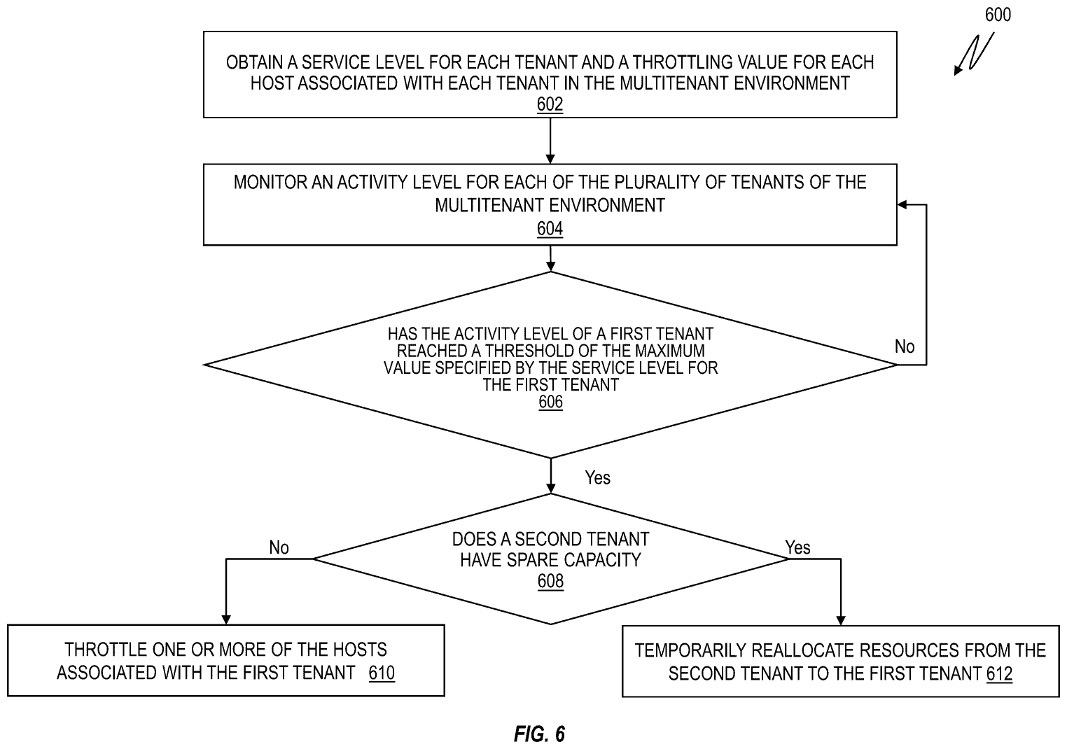

Referring now to FIG. 6, a flowchart of a method 600 for throttling in a multitenant environment in accordance with one or more embodiments of the present disclosure is shown. As shown at block 602, the method 600 includes obtaining a service level for each tenant and a throttling value for each host associated with each tenant in the multitenant environment. Next, as shown at block 604, the method 600 includes monitoring an activity level for each of the plurality of tenants of the multitenant environment. In exemplary embodiments, the activity level of a tenant is calculated as the sum of the activity levels of each of the hosts associated with the tenant.

As shown at decision block 606, the method 600 includes determining whether the activity level of a first tenant within a threshold of a maximum value specified by the service level for the first tenant. Based on a determination that the activity level of the first tenant has reached the threshold of a maximum value specified by the service level for the first tenant, the method 600 proceeds to decision block 608. As shown at decision block 608, the method 600 includes determining whether a second tenant of the multitenant environment has spare capacity. In exemplary embodiments, a determination that the second tenant of the multitenant environment has spare capacity is based on determining that the activity level of the second tenant is lower that a second threshold of the maximum value of the service level associated with the second tenant. For example, is the second tenant using less than fifty percent of the maximum value of its associated service level.

Based on determining that the second tenant has spare capacity, the method 600 proceeds to block 612 and temporarily reallocates resources from the second tenant to the first tenant. In exemplary embodiments, the first tenant is billed for the resources reallocated from the second tenant and the second tenant is credited with at least a portion of the amount that was billed to the first tenant. In one embodiment, the service provider of the multitenant environment keeps a portion of the amount billed to the first tenant as a fee for facilitating the temporary reallocation. Based on determining that none of the remaining tenants of the multitenant environment have spare capacity, the method 600 proceeds to block 610 and throttles one or more of the hosts associated with the first tenant.

Various embodiments are described herein with reference to the related drawings. Alternative embodiments can be devised without departing from the scope of the present disclosure. Various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the present disclosure may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,”“comprising,”“includes,”“including,”“has,”“having,”“contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,”“substantially,”“approximately,” and variations thereof, are intended to include the degree of error associated with measurement of the particular quantity based upon the equipment available at the time of filing the application. For example, “about” can include a range of ±8% or 5%, or 2% of a given value.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A method for throttling in a multitenant environment, comprising:
assigning, by a system administrator of the multitenant environment, a service level for each tenant of a plurality of tenants of the multitenant environment;
obtaining a throttling value for each of a plurality of hosts associated with each of the plurality of tenants in the multitenant environment;
monitoring, by a controller of the multitenant environment, an activity level for each of the plurality of tenants of the multitenant environment; and
based on a determination that the activity level for one of the plurality of tenants has reached a maximum value specified by the service level, throttling one or more of the plurality of hosts associated with the one of the plurality of tenants based on the throttling value for the one or more of the plurality of hosts.

2. The method of claim 1, wherein the maximum value specified by the service level is one of a maximum number of on input/output operations per second (IOPS) permitted by the tenant and a maximum bandwidth.

3. The method of claim 1, wherein a sum of the throttling values for the plurality of hosts associated with the tenant is equal to the maximum value specified by the service level.

4. The method of claim 1, wherein a sum of the throttling values for the plurality of hosts associated with the tenant is greater than the maximum value specified by the service level.

5. The method of claim 4, wherein the throttling of a first host of the plurality of hosts is calculated by dividing the throttling value for the first host by the sum of the throttling values for the plurality of hosts and multiplying a quotient by the maximum value specified by the service level.

6. The method of claim 1, wherein the throttling value for each of a plurality of hosts associated with a tenant of the plurality of tenants are received from the tenant.

7. The method of claim 1, wherein the throttling value for each of a plurality of hosts are initially set to a default value and are automatically updated during operation of the multitenant environment based on a machine learning algorithm.

8. The method of claim 1, further comprising determining whether the one of the plurality of tenants can borrow additional resources from a second tenant of the plurality of tenants based on a determination that the activity level for one of the plurality of tenants is within a threshold of the maximum value specified by the service level.

9. The method of claim 8, wherein the determination that the one of the plurality of tenants can borrow additional resources from the second tenant of the plurality of tenants is based on difference between the service level of the second tenant and the activity level of the second tenant.

10. The method of claim 8, further comprising notifying the one of the plurality of tenants of an availability of the additional resources from the second tenant and a cost associated with borrowing the additional resources from the second tenant.

11. The method of claim 1, further comprising notifying the one of the plurality of tenants of a throttling even based on the throttling of the one or more of the plurality of hosts associated with the one of the plurality of tenants.

12. The method of claim 11, wherein a notification includes one or more of an indication of a current service level of the tenant, a cost of the current service level, a higher service level, and a cost difference between the cost of the current service level and the higher service level.

13. A computing system having a memory having computer readable instructions and one or more processors for executing the computer readable instructions, the computer readable instructions controlling the one or more processors to perform operations comprising:
assigning, by a system administrator of a multitenant environment, a service level for each tenant of a plurality of tenants of the multitenant environment;
obtaining a throttling value for each of a plurality of hosts associated with each of the plurality of tenants in the multitenant environment;
monitoring, by a controller of the multitenant environment, an activity level for each of the plurality of tenants of the multitenant environment; and
based on a determination that the activity level for one of the plurality of tenants has reached a maximum value specified by the service level, throttling one or more of the plurality of hosts associated with the one of the plurality of tenants based on the throttling value for the one or more of the plurality of hosts.

14. The computing system of claim 13, wherein the maximum value specified by the service level is one of a maximum number of on input/output operations per second (IOPS) permitted by the tenant and a maximum bandwidth.

15. The computing system of claim 13, wherein a sum of the throttling values for the plurality of hosts associated with the tenant is equal to the maximum value specified by the service level.

16. The computing system of claim 13, wherein a sum of the throttling values for the plurality of hosts associated with the tenant is greater than the maximum value specified by the service level.

17. The computing system of claim 16, wherein the throttling of a first host of the plurality of hosts is calculated by dividing the throttling value for the first host by the sum of the throttling values for the plurality of hosts and multiplying a quotient by the maximum value specified by the service level.

18. The computing system of claim 13, wherein the throttling value for each of a plurality of hosts associated with a tenant of the plurality of tenants are received from the tenant.

19. The computing system of claim 13, wherein the throttling value for each of a plurality of hosts are initially set to a default value and are automatically updated during operation of the multitenant environment based on a machine learning algorithm.

20. A computer program product comprising a computer readable storage medium having program instructions embodied therewith, the program instructions executable by a processor to cause the processor to perform operations comprising:
assigning, by a system administrator of a multitenant environment, a service level for each tenant of a plurality of tenants of the multitenant environment;
obtaining a throttling value for each of a plurality of hosts associated with each of the plurality of tenants in the multitenant environment;
monitoring, by a controller of the multitenant environment, an activity level for each of the plurality of tenants of the multitenant environment; and
based on a determination that the activity level for one of the plurality of tenants has reached a maximum value specified by the service level, throttling one or more of the plurality of hosts associated with the one of the plurality of tenants based on the throttling value for the one or more of the plurality of hosts.
